(19) United States
(12) Patent Application Publication
(10) Pub. No.: US 2008/0164758 A1
(43) Pub. Date: Jul. 10, 2008

(54) Electrical accessory charging compartment for a cabinet and retrofit components therefor

(76) Inventors: Richard A. McCoy, Stevensville, MI (US); Ameresh B. Viswanathan, St. Joseph, MI (US); Gale R. Horst, Watervliet, MI (US); John M. Knight, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/649,932

(22) Filed: Jan. 4, 2007

(51) Int. Cl. H02J 4/00

(52) U.S. Cl. 307/43; 320/107; 320/103; 340/636.13; 320/134

(57) ABSTRACT

An electrical accessory charging compartment, an interface device and a retrofit for creating a charging compartment and a cabinet with an lectrical accessory charging compartment on its exterior. A plurality of electrical connections is located in the charging compartment for supplying electricity to a plurality of consumer electronic devices simultaneously. A plurality of data connections is located in the charging compartment for transmitting data to and from the plurality of consumer electronic devices simultaneously. The interface device for a plurality of consumer electronic devices is provided with a connector member having a plurality of outlets arranged to supply electrical power and provide data connections to a plurality of consumer electronic devices, and a data connector arranged to be connected to a data network.

### BACKGROUND OF THE INVENTION

In a home setting, where many different appliances are often located, people are using, and recharging, various consumer electronic devices, such as cell phones, PDAs, MP3 and other digital music players, CD players, DVD players, portable radios, palm computers, hand held electronic game consoles, web tablets, etc. Typically each of these devices requires its own specialized power supply for recharging or electrically powering the device during use. The availability of spare electrically outlets in a room, such as the kitchen, may be quite limited, requiring users to alternate the use or recharging of their various electronic devices. Also, the number and variety of these devices used or stored, even temporarily, in kitchens, bedrooms, bathrooms, and other rooms, causes a loss of counter space, clutter, loss or mislocation of adaptors, shortage of available outlets, as well as possible damages to the electronic devices in environments which include high humidity or splashing water, excessive heat or cold, and errant debris, such as food particles.

Various appliances are known that provide for the heating, cooling or washing of articles in a home environment, such as a refrigerator, freezer, dishwasher, microwave oven, wall oven, stove, clothes washing machine, clothes dryer, clothes refresher and ice maker. Such appliances typically are designed to provide a single function, such as the cooling of food items in a refrigerator, the heating of food items in a stove or the washing of clothing articles in a clothes washer. Various types of cabinets are also well known, however, such cabinets typically are provided to merely store items, and are not provided with the types of connections or receptacles necessary to power or recharge multiple consumer electronic devices simultaneously.

It would be an improvement in the art if there were provided an appliance or cabinet with an arrangement in a charging compartment for powering or recharging multiple consumer electronic devices simultaneously, while collecting and protecting the devices.

### SUMMARY OF THE INVENTION

The present invention provides a compartment with a plurality of connectors for consumer electronic devices and similar electrical accessories, to provide operating and/or recharging power to the consumer electronic devices and to transmit data to and from the consumer electronic devices. This compartment, which may stand alone, or be located in a cabinet or appliance, allows a variety of consumer electronic devices, as well as their adaptors, if required, to be stored in a single location, reducing the possibility that devices or their adaptors will be misplaced, and protecting the devices and their adaptors from environmental hazards located in various rooms in a home.

In an embodiment of the invention, an appliance has a cabinet defining an exterior of the appliance and a compartment interior of the cabinet in which an article is one of washed, heated or cooled. The appliance also includes a compartment such as a drawer accessible from exterior of the cabinet and separate from the compartment. In the drawer are located a plurality of electrical connections, either wired or wireless, for supplying electricity to a plurality of consumer electronic devices simultaneously.

In an embodiment, the plurality of electrical connections could be provided in the drawer for supplying electricity to a plurality of individual voltage adapters associated with each of the plurality of consumer electronic devices, so that the adapters and consumer electronic devices could all be stored in the drawer, thereby alleviating mess and clutter and permitting all of the devices and their adaptors to be located in one convenient location.

In an embodiment, the drawer includes a portion that slides outwardly from the housing.

In an embodiment, the drawer includes a door to normally close the drawer from the exterior.

In an embodiment, the drawer comprises a stationary shelf.

In an embodiment, the drawer comprises a door that folds down to form a shelf when open.

In an embodiment, the appliance includes a sliding door to provide access to an interior of the drawer.

In an embodiment, the plurality of electrical connections comprise supplies of alternating current voltage.

In an embodiment, the plurality of electrical connections comprise supplies of normal household current and voltage.

In an embodiment, the plurality of electrical connections comprise supplies of direct current voltage.

In an embodiment, the plurality of electrical connections comprises supplies of direct current voltage at a plurality of selectable voltage levels that may be manually selectable, automatically selectable, manually configurable or automatically configurable. The voltage levels may be selectable by the user via manual adjustments, such as selection switches, or may be selected via the physical configuration of the connector interposed between the electrical connection and the consumer electric device, such as by the number or arrangement of the connection pins in the connector.

In an embodiment, the drawer includes receptacles for receiving a plurality of differently configured consumer electronic devices. In an embodiment, the appliance is one of a refrigerator, freezer, dishwasher, microwave oven, wall oven, stove, clothes washing machine, clothes dryer, clothes refresher, hot water heater and ice maker.

In an embodiment, a plurality of data connections are also located in the drawer for transmitting data to and from the plurality of consumer electronic devices simultaneously.

In an embodiment of the invention, an interface device for a plurality of consumer electronic devices is provided which includes a connector member having a plurality of outlets arranged to supply electrical power and provide data connections to a plurality of consumer electronic devices, and a data connector arranged to be connected to a data network. The interface device could be located in a stand alone compartment or a drawer of an appliance or a cabinet.

In an embodiment, a power connector is also arranged to be connected from the connector member to a source of household electrical power.

In an embodiment, an electrical potential storage device is also incorporated into the connector member.

In an embodiment, the electrical potential storage device comprises a rechargeable battery.

In an embodiment, the rechargeable battery includes an indicator to signal when the rechargeable battery requires recharging.

In an embodiment, the electrical potential storage device includes an over current indicator to signal when too many consumer electronic devices are connected to the electrical potential storage device.

In an embodiment, the connector member is provided with a plurality of standard docking interfaces for connection with docking adaptors interposed between the connector member and the consumer electronic devices.

In an embodiment of the invention, a cabinet having an exterior and a drawer accessible from the exterior of the cabinet is provided which includes a plurality of electrical connections located in the drawer for supplying electricity to a plurality of consumer electronic devices simultaneously, a plurality of data connections located in the drawer for transmitting data to and from the plurality of consumer electronic devices simultaneously, and a data connector arranged to connect the plurality of data connections to a data network.

In an embodiment, the cabinet is the cabinet of a household appliance.

In an embodiment, the cabinet is a kitchen cabinet.

In an embodiment, the cabinet is an undercounter drawer.

In an embodiment, the cabinet is a bathroom vanity.

In an embodiment, the cabinet is a bedroom dresser.

In an embodiment, a power connector is also arranged to connect the plurality of electrical connections to a source of household electrical power.

In an embodiment, a connector member is also provided, incorporating the plurality of electrical connections and the plurality of data connections therein and with an electrical potential storage device incorporated into the connector member.

### BRIEF DESCRIPTION OF THE DRAWING

FIG. 1 is a perspective view of a refrigeration appliance incorporating a drawer embodying the principles of the present invention.

FIG. 2 is a partial perspective view of a cabinet structure with an embodiment of a drawer embodying the principles of the present invention.

FIG. 3 is a partial perspective view of a cabinet structure with another embodiment of a drawer embodying the principles of the present invention.

FIG. 4 is a partial elevational view of the cabinet structure and door of FIG. 3.

FIG. 5 is a partial perspective view of a cabinet structure with a drawer embodying the principles of the present invention.

FIG. 6 is a partial side elevational view of the cabinet structure and door of FIG. 5.

FIG. 7 is a perspective view of a docking station, adaptor and consumer electronic device in accordance with the principles of the present invention.

### DETAILED DESCRIPTION OF THE PREFERRED EMBODIMENTS

The present invention, in an embodiment, provides an appliance or cabinet with a compartment such as drawer having a plurality of connectors for consumer electronic devices, to provide power to operate or recharge the consumer electronic devices and to transmit data to and from the consumer electronic devices. The compartment and its enclosure, may comprise the appliance itself, or the compartment may be located in an appliance that provides other functions. Specific embodiments of drawer and electrical connector systems containing these features, as well as some additional features are described below. Other examples of portions of such systems or related systems are described in the following related applications filed contemporaneously herewith: U.S. Patent Application entitled “A System for Supplying Service from an Appliance to Multiple Consumer Electronic Devices”, bearing applicant's docket number US20060570; U.S. Patent Application entitled “A System for Connecting Dissimilar Consumer Electronic Devices to a Host”, bearing applicant's docket number US20060678; U.S. Patent Application entitled “An Appliance with an Adapter to Simultaneously Couple Multiple Consumer Electronic Devices”, bearing applicant's docket number US20060679; U.S. Patent Application entitled “An Appliance with an Adapter to Alternately Couple Multiple Consumer Electronic Devices”, bearing applicant's docket number US20060680; U.S. Patent Application entitled “An Appliance with a Removable Adapter and a Removable Consumer Electronic Device”, bearing applicant's docket number US20060681; U.S. Patent Application entitled “A Host with Multiple Adapters for Coupling Consumer Electronic Devices”, bearing applicant's docket number US20060682; U.S. Patent Application entitled “An Adapter for Coupling a Host and Consumer Electronic Device Having Dissimilar Standardized Interfaces”, bearing applicant's docket number US20060683; U.S. Patent Application entitled “A Host with Multiple Adapters for Multiple Consumer Electronic Devices”, bearing applicant's docket number US20060684; U.S. Patent Application entitled “Multiple Hosts with Multiple Adapters for Multiple Consumer Electronic Devices”, bearing applicant's docket number US20060685; U.S. Patent Application entitled “An Appliance Door with a Service Interface”, bearing applicant's docket number US20060686; U.S. Patent Application entitled “A Cabinet Door with a Service Interface”, bearing applicant's docket number US20060687; U.S. Patent Application entitled “A Refrigerator Dispenser with a Service Interface and Adapter for a Consumer Electronic Device”, bearing applicant's docket number US20060688; U.S. Patent Application entitled “A Service Supply Module and Adapter for a Consumer Electronic Device”, bearing applicant's docket number US200600689; U.S. Patent Application entitled “Host and Adapter for Docking a Consumer Electronic Device in Discrete Orientations”, bearing applicant's docket number US20060651; U.S. Patent Application entitled “Host and Adapter for Selectively Positioning a Consumer Electronic Display in Visible and Concealed Orientations”, bearing applicant's docket number US20060690; U.S. Patent Application entitled “Host and Adapter for Selectively Positioning a Consumer Electronic Device in Accessible and Inaccessible Orientations”, bearing applicant's docket number US20060691; U.S. Patent Application entitled “Functional Adapter for a Consumer Electronic Device”, bearing applicant's docket number US20060630; U.S. Patent Application entitled “Adapter and Consumer Electronic Device Functional Unit”, bearing applicant's docket number US20060674; U.S. Patent Application entitled “Acoustic Chamber as part of Adapter or Appliance”, bearing applicant's docket number US20060669; all of which are incorporated herein by reference in their entirety.

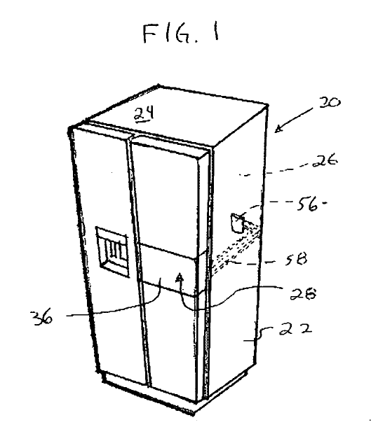

In an embodiment of the invention, as illustrated in FIG. 1, an appliance 20 has a cabinet 22 defining an exterior 24 of the appliance and a primary compartment 26 interior of the cabinet in which an article is one of washed, heated or cooled. Although FIG. 1 illustrates a side-by-side refrigerator as the appliance, the present invention is not limited to such an environment, and could be employed in any type of appliance. For example, the article could comprise a food article, such as a strip of bacon that could be cooled in a refrigerator compartment, frozen in a freezer compartment, or heated in an oven or stove, or in a microwave oven. The article could be a clothing article that is washed in a clothes washer or clothes refresher or heated and dried in a clothes dryer. The article could be dishware that is washed in a dishwasher. The article could be a quantity of water that is heated in any of the mentioned ovens or in a hot water heater, cooled in a refrigerator or frozen in a freezer or ice maker. The cabinet 22 might not be associated with an appliance, but might be a kitchen cabinet, an undercounter kitchen drawer, a bedroom dresser or a bathroom vanity, or similar type of built-in or freestanding cabinet structure.

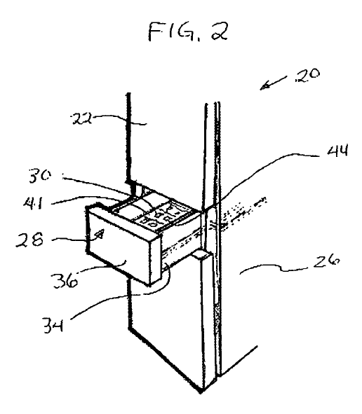

The appliance 20 also includes a charging compartment such as drawer 28 accessible from exterior of the cabinet 22 and separate from the primary compartment 26. The term drawer is meant to include any type of enclosed space that is accessible by a movable portion, referred to herein as a door. As shown in FIG. 2, in the drawer 28 are located a plurality of electrical connections 30 for supplying electricity to a plurality of consumer electronic devices 32 simultaneously. The electrical connections 30 could be hard wired connections, as illustrated, or could be in the form of wireless connections, as well known in the art. The wireless connections could transmit electrical power to the consumer electronic devices without a physical connection to the consumer electronic device.

In an embodiment, as shown in FIGS. 2-4, the drawer 28 includes a portion 34 that slides outwardly from the cabinet 22. The sliding portion 34 might be spring loaded, with a catch, so that a first push would release the sliding portion, and cause it to project outwardly of the appliance 20, and a second push would reposition the sliding portion back into a recessed position in the appliance. Alternatively, the sliding portion 34 could be manually moved from the recessed position to the outwardly projecting position.

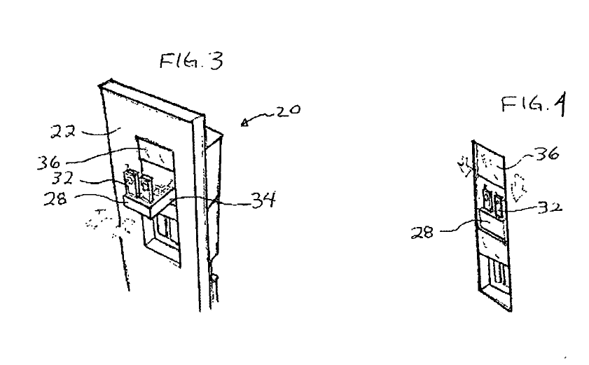

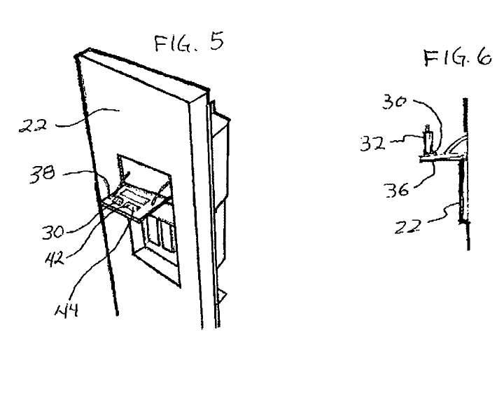

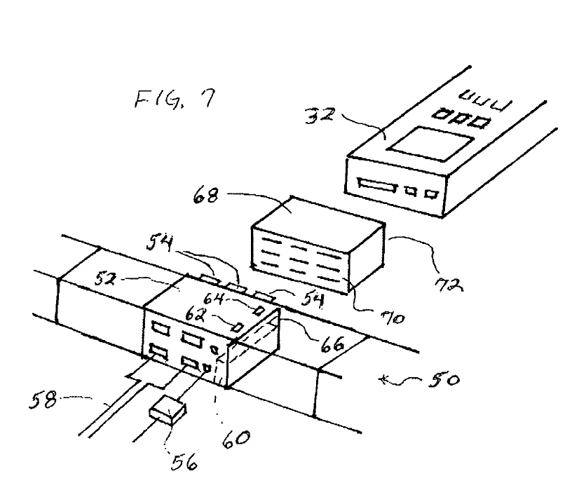

In an embodiment, as shown in FIGS. 1-6, the drawer 28 includes a door 36 to normally close the drawer from exterior of the cabinet 22. The door 36 could be arranged to pivot outwardly, either about a vertical axis or about a horizontal access. When pivoting about a horizontal axis, the door 36 could present a fold-down shelf-like surface 38 with electrical connections 30 for receiving the various consumer electronic devices 32 (FIGS. 5-6). Alternatively, the door 36 could be arranged to slide vertically, as shown in FIGS. 3-4, or horizontally, between an open position and a closed position. In an embodiment having the openable door 36, the drawer 28 could also comprise a stationary shelf 40 accessible when the door is opened.

In an embodiment, the plurality of electrical connections 30 comprise supplies of alternating current voltage. For example, the plurality of electrical connections 30 could comprise supplies of normal household current and voltage. These connections 30 could be in the form of a plurality of regular household outlets, such as an ac outlet strip, with or without ground wire apertures, to receive regular plugs from extension cords or power cables, prongs on voltage adapters, or other similar connections.

In an embodiment, the plurality of electrical connections 30 comprise supplies of direct current voltage. For example, the plurality of electrical connections 30 could be in the form of a plurality of selectable voltage levels at the various connections. In an embodiment, the plurality of electrical connections comprises supplies of direct current voltage at a plurality of voltage levels that may be manually selectable, automatically selectable, manually configurable or automatically configurable. The voltage levels may be selectable by the user via manual adjustments, such as selection switches, or may be selected via the physical configuration of the connector interposed between the electrical connection and the consumer electric device, such as by the number or arrangement of the connection pins in the connector. Alternatively, the various connections 30 could have different, but fixed voltage levels, such that at least one connection would provide a first voltage level and at least one other connection would provide a second voltage level. More than two voltage levels could be provided in this manner. Voltage transforming circuits could be provided in a unit 41 housing the various connections 30 in the drawer 28. In a further alternate arrangement, the correct voltage level at each connection 30 could be provided by device identification. For example, device identification could be a discovery message sent by the consumer electronic device 32 to a power management component which could interpret the message and determine and create the correct voltage and deliver the correct voltage to the consumer electronic device via an adaptive connector at each connection 30. In an embodiment, the drawer 28 includes receptacles 42 for receiving the plurality of differently configured consumer electronic devices 32. These receptacles 42 could be static, unchangeable receptacles, such as various sized recesses, or they could be receptacles with movable wall portions to snugly accommodate differently configured consumer electronic devices 32.

In an embodiment, a plurality of data connections 44 are also located in the drawer 28 for transmitting data to and from the plurality of consumer electronic devices 32 simultaneously. The plurality of data connections 44 may be separate from the electrical connections 30 or the data connections and the electrical connections may be provided in the same plug. As with the electrical connections 30, the data connections 44 may either be hard wired, or wireless. The data connections 44 may have further connections to a data network, such as a local area network in the home or office, or a wider network like the internet. Such an arrangement would permit the consumer electronic devices 32 which are connected to the data connections 44 to be operated remotely, and/or to transmit data stored thereon, to remote devices, such as to displays, speakers or data storage devices.

In an embodiment of the invention, as shown in FIG. 7, an interface device 50, such as a docking station for the plurality of consumer electronic devices 32, is provided which includes a connector member 52 having a plurality of connectors 54 arranged to supply electrical power and provide data connections to the plurality of consumer electronic devices, and a data connector 56 arranged to be connected to a data network. The interface device 50 could comprise a retrofit kit to be received in a drawer 28 of an existing cabinet, or could be incorporated into a drawer of a cabinet as originally manufactured. The data connector 56 may be a wire connection (like Ethernet or USB), or a wireless connection, such as RF, WI-FI, bluetooth®, or any other wireless type of connection. The electrical power connectors may also be wireless, with the interface device merely providing a mechanical connection to the consumer electronic device 32 for locating and proximity purposes.

In an embodiment, a power connector 58, such as an electrical wire, is also arranged to be connected from the connector member 52 to a source of household electrical power.

In another embodiment, an electrical charge storage device 60 is also incorporated into the connector member 52. For example, the electrical charge storage device 60 might be a rechargeable battery. In such case, the rechargeable battery 60 might include an indicator 62 to signal when the rechargeable battery requires recharging or an over current indicator 64 to signal when too many consumer electronic devices 32 are connected to the electrical charge storage device. The electrical charge storage device 60 may be used to power or recharge many different consumer electronic devices before it requires recharging itself. The rechargeable battery 60 may be provided with voltage adapters to provide powering or recharging current to various different consumer electronic devices at various voltage levels, as required by a particular consumer electronic device.

In an embodiment, the connector member 52 is provided with a plurality of standard docking interfaces 66 for connection with docking adaptors 68 interposed between the connector member and the consumer electronic devices 32. The docking adaptors 68 could have one face 70 arranged to physically and electrically mate with the docking interfaces 66, and could have a second face 72 arranged to physically and electrically mate with a particular consumer electronic device 32. In this manner, any type of consumer electronic device 32 and its associated docking adaptor 68 could mate with the connector member 52 at any of the docking interfaces 66.

When the interface device 50 is provided as a retrofit kit, it could be in the form of a charging insert placed inside a drawer 28. The charging insert could be the connector member 52 with the plurality of connectors 54 able to receive the plurality of docking adaptors 68. In addition to the charging insert, the rechargeable battery 60 could be added which could be plugged into an AC supply. Alternatively, instead of the battery 60, an AC to DC converter could be provided in the interface device 50. Various features of the appliances, drawers, cabinets and interface devices have been described which may be incorporated singly or in various combinations into a desired system, even though only certain combinations are described herein. The described combinations should not be viewed in a limiting way, but only as illustrative examples of particular possible combinations of features.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1-30. (canceled)

31. An appliance comprising:
a cabinet defining a portion of the appliance:
a charging compartment selectively openeable to be accessible from the exterior of the cabinet and selectively closeable to be inaccessible from the exterior of the cabinet,
a power source within the charging compartment capable of receiving power from a power source external to the cabinet,
a plurality of electrical connections located within the charging compartment capable of supplying electricity to a plurality of consumer electronic devices simultaneously.

32. The appliance of claim 31 further comprising a primary compartment accessible separate from the charging compartment in which an article is processed.

33. The appliance of claim 31, wherein the cabinet is a household storage cabinet.

34. The appliance of claim 31, wherein the plurality of electrical connections comprises supplies of voltage at a plurality of voltage levels.

35. The appliance of claim 31, wherein the voltage levels of claim 7 are automatically determined.

36. The appliance of claim 31, wherein the charging compartment includes receptacles capable of receiving a plurality of differently configured consumer electronic devices.

37. The appliance of claim 31, including a plurality of data connections located in the charging compartment capable of transmitting data to and from the plurality of consumer electronic devices simultaneously.

38. The appliance of claim 31 further comprising a data connector arranged to be connected to a data network.

39. The appliance of claim 31 further comprising:
a connector member having a plurality of outlets arranged to supply electrical power and provide data connections to a plurality of consumer electronic devices, and
a power connector arranged to be connected from the connector member to a source of household electrical power.

40. The appliance of claim 39, including an electrical potential storage device incorporated into the connector member.

41. The appliance of claim 31, wherein the charging compartment is sized and configured to receive power adaptors for each of the consumer electronic devices in addition to the consumer electronic devices.

42. The appliance of claim 31, wherein the electrical potential storage device comprises a rechargeable battery.

43. The appliance of claim 31 further comprising a primary compartment accessible separate from the charging compartment in which an article is one of washed, heated or cooled.

44. The appliance of claim 31, wherein the appliance is one of a refrigerator, freezer, dishwasher, microwave oven, wall oven, stove, clothes washing machine, clothes dryer, clothes refresher, water heater and ice maker.

45. The appliance of claim 31, wherein the cabinet is one of a kitchen cabinet, undercounter kitchen drawer, a bathroom vanity, and a bedroom dresser.

46. The appliance of claim 31, wherein the electrical potential storage device includes an over current indicator to signal when the devices connected to the electrical potential storage device are demanding too high a level of current.

47. The appliance of claim 31, wherein the connector member is provided with a plurality of standard docking interfaces capable of connection with docking adaptors interposed between the connector member and the consumer electronic devices.

48. The appliance of claim 31, wherein the charging compartment comprises at least one of:
a stationary shelf
a portion that slides outwardly from the housing;
a drawer;
a movable door to normally close the charging compartment from the exterior; and
a door that folds down to form a shelf when open.

49. An interface device for a plurality of consumer electronic devices, comprising:
a connector member having a plurality of outlets arranged to supply electrical power and provide data connections to a plurality of consumer electronic devices,
a power connector arranged to be connected from the connector member to a source of household electrical power, and
a data connector arranged to be connected to a data network.

50. An interface device according to claim 49, including an electrical potential storage device incorporated into the connector member.

51. An interface device according to claim 50, wherein the electrical potential storage device comprises a rechargeable battery.

52. An interface device according to claim 51, wherein the rechargeable battery includes an indicator to signal when the rechargeable battery requires recharging.

53. An interface device according to claim 51, wherein the electrical potential storage device includes an over current indicator to signal when too many consumer electronic devices are connected to the electrical potential storage device.

54. An interface device according to claim 49, wherein the connector member is provided with a plurality of standard docking interfaces capable of connection with docking adaptors interposed between the connector member and the consumer electronic devices.

55. A retrofit kit for an enclosed cabinet compartment comprising:
an interface device arranged to be received in the compartment and, in turn, to receive a plurality of consumer electronic devices, the interface device including:
a connector member having a plurality of outlets arranged to supply electrical power and provide data connections to a plurality of consumer electronic devices, and
a data connector arranged to be connected to a data network.

56. The retrofit kit of claim 55 further comprising a plurality of standard docking interfaces capable of connection with docking adaptors interposed between the connector member and the consumer electronic devices.

57. The retrofit kit of claim 55 further comprising an electrical potential storage device incorporated into the connector member.

58. The retrofit kit of claim 55 further comprising a plurality of data connections located in the charging compartment capable of transmitting data to and from the plurality of consumer electronic devices simultaneously.
